(19) United States
(12) Patent Application Publication
(10) Pub. No.: US 2006/0218603 A1
(43) Pub. Date: Sep. 28, 2006

(54) AV transmission system

(75) Inventor: Takaharu Kanehira, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/387,870

(22) Filed: Mar. 24, 2006

(30) Foreign Application Priority Data
Mar. 25, 2005 (JP) 2005-087801

(51) Int. Cl. H04N 7/173

(52) U.S. Cl. 725/89; 725/88; 725/134

(57) ABSTRACT

A time lag generated during device operation is reduced at a low cost in an AV system for transmitting streaming data of videos and audios from a server device to output it from a client device. The AV transmission system includes the server device for transmitting video and audio data, and a client device for receiving the video and audio data and demodulating them to video and audio signals to output the same. When a reproduction stop operation command or a reproduction skip operation command is input, a control unit of the client device discards buffered video and audio data of the client device side, and a control unit of the server device discards buffered video and audio data of the server device side.

### BACKGROUND OF THE INVENTION

1. Field of the Invention

The present invention relates to an AV transmission system which transmits streaming data of videos and audios from a server device by radio to enable video viewing and listening on a client device side.

2. Description of the Related Art

There has recently been developed an AV transmission system which transmits streaming data of videos and audios from a server device by radio to enable video viewing and listening on a client device side. A circuit for converting a bit rate of the streaming data has been put to practical use, and a progress has been made in development of an AV transmission system which includes this bit rate conversion circuit mounted on the server device.

According to such an AV transmission system, the data of a video and an audio is read from a recording medium such as an optical disk or a hard disk, put through some data processing operations including bit rate conversion, radio transmission, and decoding to be demodulated to a video signal and an audio signal, and the video and the audio are output from a television receiver or the like. In the process of such data processing, to process continuously sent stream data without a break, video data and audio data before and after processing are stored in a buffer memory to be processed.

Buffering of the video/audio data is important for processing the streaming data without a break. On the other hand, this buffering has a drawback of generating a time lag of, e.g., about 400 milliseconds to 2 seconds in a period from reading of the video/audio data to its outputting from the television receiver.

As a device similar to the AV transmission system, there has conventionally been developed a data distribution system which digitizes an analog video/audio signal in real time, and sends it to a remote receiver through a network to enable video viewing and listening on the receiver side. Regarding such a data distribution system, a technology has been proposed which increases a response speed of a remote-control operation by dynamically changing an overflow threshold value of a buffer memory to temporarily increase a reproduction speed in the receiver when the receiver is remote-controlled (Patent Document 1).

Patent Document 1: JP A 2004-356695

In the AV transmission system, the time lag is generated from the reading of the video/audio data to the outputting of the video/audio as described above. Thus, for example, even when the user performs an operation such as chapter skipping, the same time lag is generated from user's operation to actual reproduction outputting of a next chapter without any ingenious measures.

In other words, even when reading of video/audio data of a next chapter is started immediately after an operation, as previously read video/audio data has been buffered through bit rate conversion, radio transmission, and decoding to wait for processing, the video/audio data of the next chapter is processed after completion of such processing. Hence, the same time lag is generated from the chapter skipping operation to the outputting of the video/audio of the next chapter.

During reproduction of video contents, the user never recognizes when the currently displayed video data has been read. Thus, the time lag from the data reading to the outputting is not noticed at all. However, as a time lag generated when the user performs a certain operation is recognized as an operation response delay, a general user feels that usability is low.

### SUMMARY OF THE INVENTION

It is therefore an object of the present invention to reduce a time lag generated during a device operation at low costs in an AV transmission system which transmits streaming data of videos/audios from a server device to output it at a client device side.

It is another object of the present invention to provide an AV transmission system capable of reducing a time lag of an operation time only when necessary by judging whether it is better to execute processing of reducing the time lag of the operation time or not according to the operation.

To achieve the aforementioned object, in accordance with the first aspect of the present invention, an AV transmission system comprises:

a server device comprising a bit rate conversion circuit for converting a bit rate of video data and audio data which are continuously sent, a buffer memory for temporarily holding the video data and the audio data to convert the bit rate, a transmission/reception section for transmitting the video and audio data and receiving a command, and a server control unit for executing overall control of the device; and

a client device comprising a transmission/reception section for receiving the video data and the audio data transmitted from the server device and for transmitting the command to the server device, a decoder circuit for decoding a video data and an audio data which are continuously sent and compressed, a buffer memory for temporarily storing the video data and the audio data for the decoding, an operation input unit for inputting an operation command from an outside, and a client control unit for executing overall control of the device, and the client device demodulating the video data and the audio data to a video signal and an audio signal to output the signals, wherein:

the client control unit is configured to discard the data held in the buffer memory of the client device side when the operation input unit inputs a reproduction stop operation command of stopping reproduction of a video and an audio to output another screen, or a reproduction skip operation command of skipping a reproduction position of the video and the audio for a limited time to continue reproduction, and to inhibit discarding of the data held in the buffer memory of the client device side when the operation input unit inputs a speed change operation command of changing a reproduction speed, and

the server control unit is configured to discard the data held in the buffer memory of the server device side when the transmission/reception section receives a command indicating the reproduction stop operation command or the reproduction skip operation command, and to inhibit discarding of the data held in the buffer memory of the server device side when the transmission/reception section receives a command indicating the speed change operation command.

In accordance with the second aspect of the present invention, an AV transmission system comprises:

a server device comprising a data processing circuit for processing video data and audio data which are continuously sent, a buffer memory for temporarily holding the video data and the audio data to process the data, a transmission/reception section for transmitting the video data and the audio data and receiving a command, and a server control unit for executing overall control of the device; and

a client device comprising a transmission/reception section for receiving the video data and the audio data transmitted from the server device and for transmitting the command to the server device, a data processing circuit for processing the video data and the audio data which are continuously sent, a buffer memory for temporarily storing the video data and the audio data to process the data, an operation input unit for inputting an operation command from an outside, and a client control unit for executing overall control of the device, and the client device demodulating the video data and the audio data to a video signal and an audio signal to output the signals, wherein:

the client control unit is configured to discard the data held in the buffer memory of the client device side and to transmit a command indicating a first operation command to the server device by the transmission/reception section when the operation input unit inputs the first operation command, and

the server control unit is configured to discard the data held in the buffer memory of the server device side when the transmission/reception section receives a command indicating the first operation command.

According to the system, when the first operation command is input, the video and audio data are discarded from the buffer memories of the server device and the client device. Thus, the video and audio data corresponding to the operation command quickly pass through each data processing circuit to output videos and audios. Thereby, a response time lag during user's operation can be reduced.

Preferably, the client control unit is configured not to discard the data held in the buffer memory of the client device side when the operation input unit inputs a second operation command, and the server control unit is configured not to discard the data held in the buffer memory of the serer device side when a command indicating the second operation command is received.

For example, when slow reproduction is operated, if processing of discarding the data of the buffer memory is executed, deletion of the video and audio data stored in the buffer memory causes skipping of some reproduction scenes to start the slow reproduction, resulting in a problem of discontinuity of videos. Thus, by selecting the data to be discarded or nondiscarded, of the buffer memory in accordance with operation contents like the above system, it is possible to prevent the problem.

Preferably, the system further comprises a setting section for setting whether an operation command input from the outside causes the data of the buffer memory to be discarded or not by an operation from the outside.

In the above system, when whether it is better to increase a response speed by discarding the data from the buffer memory or to maintain continuity of videos without discarding the data depends on user's preference, the user can selectively set it by the setting section in accordance with user's preference.

Preferably, the first operation command contains a reproduction stop operation command of stopping reproduction of a video and an audio to output another screen, or a reproduction skip operation command of skipping a reproduction position of the video and the audio for a limited time to continue reproduction. The second operation command contains a speed change operation command of changing a reproduction speed.

More preferably, the data processing circuit of the server device comprises a bit rate conversion circuit for converting a bit rate of the video data and the audio data, or a transmission processing circuit for converting the video data and the audio data into a data form which is transmittable by the transmission/reception section. The data processing circuit of the client device comprises a decoder circuit for decoding a video data and an audio data which are compressed.

As described above, according to the present invention, because during user's operation, such as skip reproduction or reproduction stop, the video and audio data are discarded from the buffer memory of the server device or the client device to quickly execute the process of video and audio data, which reflects the operation, a time lag during the operation can be reduced to quicken response to the operation.

In the system, by selecting whether the data of the buffer memory is discarded in accordance with operation contents, it is possible to maintain continuity of videos without discarding the data from the buffer memory in the case of an operation where it is better to maintain the video continuity than operation responsiveness.

Furthermore, in the system, by setting the operation of discarding the data or the operation of not discarding the data from the buffer memory from the outside, it is possible to customize operation processing by discarding the data from the buffer memory to improve responsiveness in the case of one operation, or by maintaining video continuity without discarding data from the buffer memory in the case of another operation in accordance with user's preference.

### BRIEF DESCRIPTION OF THE DRAWINGS

The present invention will become more fully understood from the detailed description given hereinbelow and the accompanying drawing which are given by way of illustration only, and thus are not intended as a definition of the limits of the present invention, and wherein;

FIG. 1 is a block diagram showing an entire configuration of an AV transmission system according to an embodiment of the present invention;

FIG. 2 is a table showing a part of an operation command list stored in a nonvolatile memory of a client device;

FIG. 3 is a flowchart showing a procedure of remote command reception processing executed by a CPU of the client device during a remote-control operation; and

FIG. 4 is a flowchart showing a procedure of remote command reception processing executed by a CPU of a server device during a remote-control operation.

### PREFERRED EMBODIMENTS OF THE INVENTION

The preferred embodiments of the present invention will be described below with reference to the accompanying drawings.

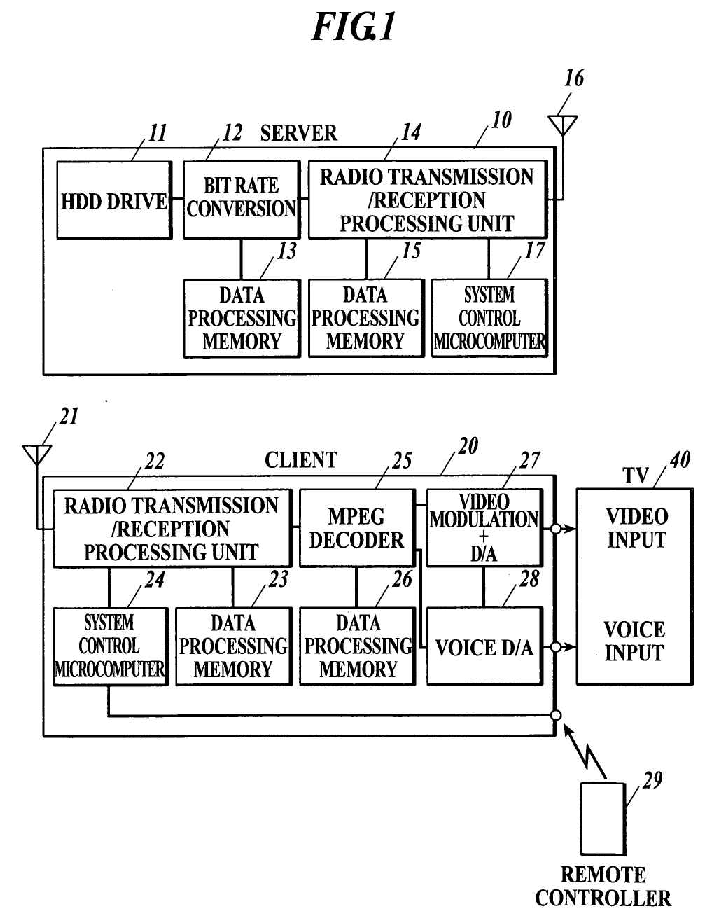

FIG. 1 is a block diagram showing an entire configuration of an AV transmission system according to an embodiment of the present invention.

The AV transmission system of the embodiment includes a server device 10 for transmitting streaming data of videos and audios by radio, and a client device 20 for receiving the streaming data from the server device 10 to output a video signal and an audio signal to an externally connected television receiver 40.

The server device 10 includes an HDD drive 11 for driving a hard disk which stores contents data such as video and audio data, a bit rate conversion circuit 12 called a transcoder for converting a bit rate of the video and audio data, a data processing memory 13 used by the bit rate conversion circuit 12, a radio transmission/reception processing unit 14 as the transmission/reception section for processing the video and audio data into a form of radio transmission and for transmitting/receiving a command, a data processing memory 15 used by the radio transmission/reception processing unit 14, an antenna 16 for transmitting/receiving a radio signal, a system control microcomputer 17 (referred to as control microcomputer 17 hereinafter) as a server control unit for executing overall control of the server device 10, and the like.

The client device 20 includes an antenna 21 for transmitting/receiving a radio signal, a radio transmission/reception processing unit 22 as the transmission/reception section for receiving data transmitted from the server device to restore video and audio data and for transmitting/receiving a command, a data processing memory 23 used by the radio transmission/reception processing unit 22, an MPEG decoder 25 for decoding the compressed video and audio data in a motion picture experts group (MPEG) form, a data processing memory 26 used by the MPEG decoder 25, a video encoder 27 for demodulating the decoded video data to a video signal to be input to the television receiver 40, an audio encoder 28 for demodulating the decoded audio data to an analog audio signal, a remote controller 29 as an operation input unit having a plurality of operation buttons to receive operation commands from the outside, a reception unit 30 to which a signal from the remote controller 29 is input, a system control microcomputer 24 (referred to as control microcomputer 24 hereinafter) as a client control unit for executing overall control of the client device 20, and the like.

Among these, in the data processing memories 13 and 15 of the server device 10 and the data processing memories 23 and 26 of the client device 20, data buffering memory areas (buffer memories) are disposed to temporarily store video and audio data which is before/after (before, after or both) streaming data during data processing.

The data processing memories 13, 15, 23, and 26 are managed by data processing circuits of the bit rate conversion circuit 12, the radio transmission/reception processing units 14 and 22, and the MPEG decoder 25. By rewriting memory management data in these data processing circuits, the data stored in the buffer memory areas can be discarded within a short time.

The control microcomputer 17 of the server device 10 is configured to instruct the radio transmission/reception processing unit 14 and the bit rate conversion circuit 12 to discard the data from the buffer memory area. The control microcomputer 24 of the client device 20 can instruct the radio transmission/reception processing unit 22 and the MPEG decoder 25 to discard the data from the buffer memory area.

A bit rate of the stream data from the HDD drive 11 to the bit rate conversion circuit 12, and from the bit rate conversion circuit 12 to the radio transmission/reception processing unit 14 enables transfer of MPEG data of DVD video image quality at a speed faster by 20 times or more. A processing rate of the bit rate conversion circuit 12 or the radio transmission/reception processing unit 14 enables processing of the MPEG data of DVD video image quality at a speed faster by 8 times.

A data transfer rate from the radio transmission/reception processing unit 14 of the server device 10 to the radio transmission/reception processing unit 22 of the client device 20, and from the radio transmission/reception processing unit 22 to the MPEG decoder 25, and a processing rate of the radio transmission/reception processing unit 22 or the MPEG decoder 25 are almost similar to the above.

Accordingly, in a state where the video and audio data of the data processing memories 13, 15, 23, and 26 have not been buffered, the streaming data read from the HDD drive 11 can be passed through the server device 10 and the client device 20 to output a video signal and an audio signal within a very short time.

In each of the control microcomputers 17 and 24 of the server device 10 and the client device 20, a nonvolatile memory for storing a control program or control data, a random access memory (RAM) for providing a work memory space, and a central processing unit (CPU) for executing the control program are disposed.

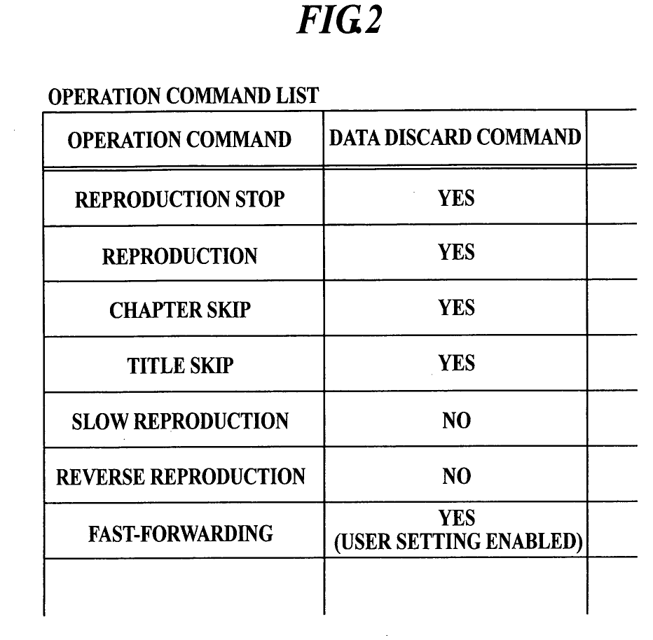

FIG. 2 shows a part of an operation command list stored in the nonvolatile memory of the client device 20.

A command code of each operation command corresponding to an operation signal input from the remote controller 29, and an operation command list indicating addition information or the like of each operation command are formed in the nonvolatile memory of the control microcomputer 24 of the client device 20.

As shown in FIG. 2, operation commands include a reproduction stop command of stopping reproduction of contents to display another screen (initial screen, reproduction menu screen, black screen, blue screen, or the like), a reproduction command of starting reproduction of contents from a displayed state of a reproduction menu, a chapter skip command of switching a reproduction position to a next chapter during the reproduction of the contents to continue the reproduction, a title skip command of switching reproduction of a next title during the reproduction of the contents, a slow reproduction command of switching a reproduction speed to ½ or ¼ (or faster by 1.2 to 2 times), a reverse reproduction command of switching a reproduction direction from normal to reverse rotation or vice versa, a fast forward command of making a reproduction speed faster by 4 to 16 times, and the like.

As shown in FIG. 2, the addition information of the operation command contains data discard command information indicating whether to discard the buffer data of each data processing circuit. In the case of several operation commands (e.g., fast forward command), the user can set the data discard command information by a remote-control operation or the like. For example, this setting method can be realized by selecting an item of operation command addition information setting from a menu screen to display the operation command list, and causing the user to select a data discard command item of a relevant operation command by a cursor button to switch presence by a decision button. The setting method constitutes the setting section.

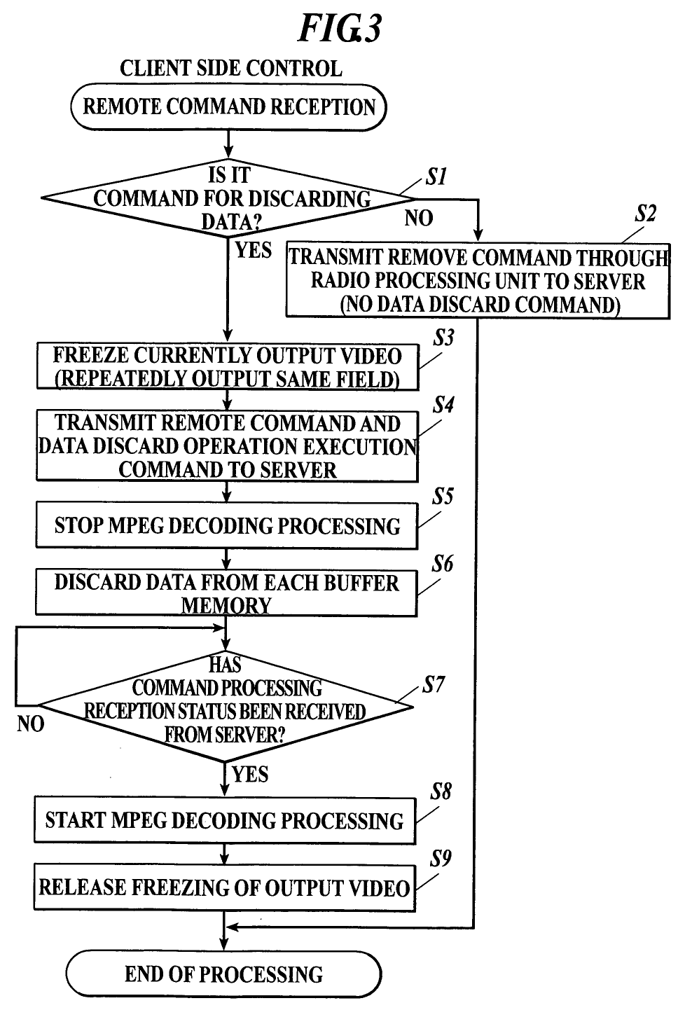

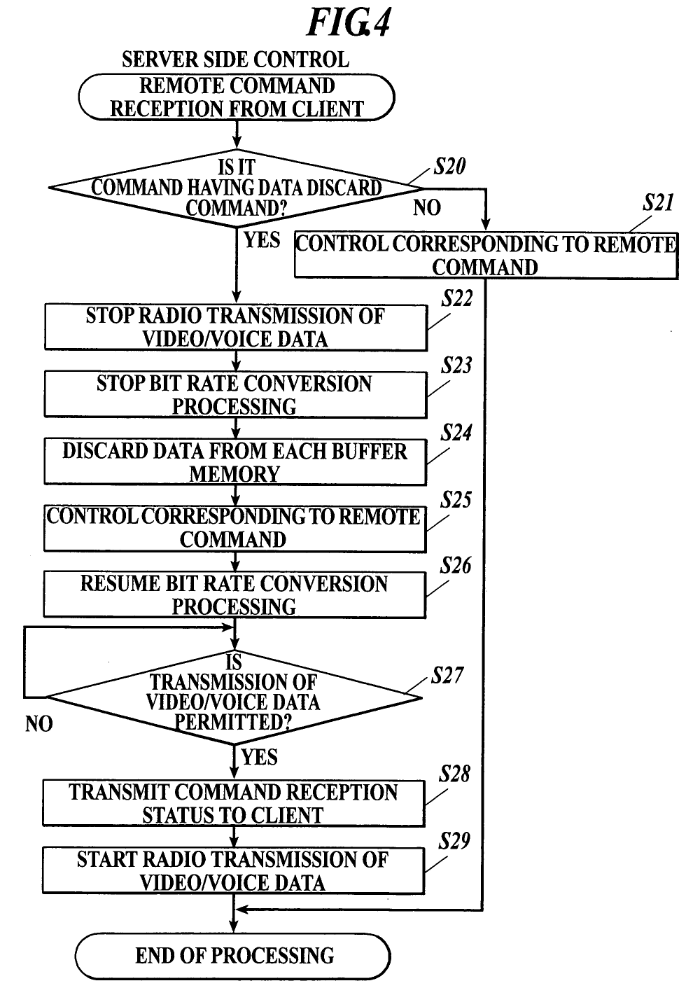

Next, an operation which is executed when the user performs a remote-control operation in the above AV transmission system will be described by referring to flowcharts of FIGS. 3 and 4.

FIG. 3 is a flowchart showing a procedure of remote command reception executed by the CPU of the client device during a remote-control operation. FIG. 4 is a flowchart showing a procedure of remote command reception executed by the CPU of the server device during a remote-control operation.

First, a case where the user operates a remote-control button of slow reproduction which is not accompanied by a data discard command, during reproduction of contents data will be described.

Upon reception of a remote-control signal of slow reproduction by the client device 20, command reception processing (FIG. 3) is started by the control microcomputer 24 of the client device 2 side. First, addition information is read by referring to the command list regarding an operation command corresponding to the operation signal, and presence of a data discard command is checked (step S1). As a result, when it is confirmed that there is no data discard command, a command indicating the slow reproduction is transmitted to the server device 10 through the radio transmission/reception processing unit 22 (step S2). On the client device 20 side, the command reception processing for the operation command is finished (FIG. 3).

In the server device 10, after the command of the slow reproduction has been input through the radio transmission/reception processing unit 14, command reception processing (FIG. 4) is started by the control microcomputer 17. First, it is checked whether a data discard command is added to the received command (step S20). As a result, when it is confirmed that no data discard command has been added, control processing corresponding to the command of the slow reproduction is executed (step S21). For example, in the case of a slow reproduction operation, processing is carried out in such a manner that during reading of streaming data from the HDD drive 11, a time control code indicating reproduction timing at each time point of the streaming data is changed to one for the slow reproduction to continuously read the rest of the streaming data. Then, the command reception processing (FIG. 4) for the operation command is finished.

Through such processing, by operating the slow reproduction button, with respect to the video and audio data read out from the HDD drive 11 before operating the slow reproduction button and buffered by the processing of each of the bit rate conversion circuit 12, the radio transmission/reception processing units 14 and 22, and the MPEG decoder 25, a video and an audio that do not reflect the slow reproduction operation are output to the TV receiver 40 until the outputting of the video and the audio is completed. Then, the streaming data read from the HDD drive 11 after the operation of the slow reproduction button, and changed in reproduction speed is sent to each circuit. Thus, the outputting of the video and the audio before the slow reproduction is accompanied by the outputting of the video and the audio changed in reproduction speed while continuity of the video and the audio is maintained.

For other operation commands having no data discard commands such as reverse reproduction, processing is executed in accordance with each operation command similarly to the case of the above slow reproduction.

Next, a case where the user operates a remote-control button of reproduction stop having a data discard command during reproduction of contents data will be described.

Upon reception of a remote-control signal of reproduction stop by the client device 20, command reception processing (FIG. 3) is started by the control microcomputer 24. First, with respect to an operation command corresponding to the operation signal, by referring to the command list, addition information is read, and presence of a data discard command is checked (step S1).

As a result, when it is confirmed that there is a data discard command, sequentially, the video encoder 27 is set in a frozen state of repeatedly outputting a video of the same field which is currently output (step S3), a command indicating reproduction stop and a data discard operation execution command are transmitted to the server side through the radio transmission/reception processing unit 22 (step S4), decoding processing of the MPEG decoder 25 is stopped (step S5), and the buffered data of the video and audio data stored in the data processing memory 23 of the radio transmission/reception processing unit 22 and the data processing memory 26 of the MPEG decoder 25 are discarded (step S6).

Subsequently, reception of a command processing reception status from the server is checked (step S7). After the checking, sequentially, the decoding processing of the MPEG decoder 25 is resumed (step S8), and the frozen state of the video encoder 27 is released (step S9). Then, the command reception processing for the operation command (FIG. 3) is finished.

In the server device 10, upon inputting of the reproduction stop command through the radio transmission/reception processing unit 14, command reception processing (FIG. 4) is stared by the control microcomputer 17. First, it is checked whether a data discard command is added to the received command (step S20).

As a result, when it is confirmed that the data discard command is added, sequentially, radio transmission of the streaming data by the radio transmission/reception processing unit 14 is stopped (step S22), processing of the bit rate conversion circuit 12 is stopped (step S23), the buffered data of the video and audio data stored in the data processing memories 13 and 15 of the bit rate conversion circuit 12 and the radio transmission/reception processing unit 14 are discarded (step S24), control (e.g., changing of data read from the HDD drive 11 to video data of initial screen, or the like) corresponding to the reproduction stop command is executed (step S25), and the data processing of the bit rate conversion circuit 12 is resumed (step S26).

Subsequently, it is checked whether the video and audio data (data of initial screen) have been stored enough in the buffer memory area of the radio transmission/reception processing unit 14 to permit transmission (step S27). If the data has been stored enough, sequentially, a command reception status indicating permission of receiving a next command is transmitted to the client device (step S28), and transmission of the video and audio data from the radio transmission/reception 14 is started (step S29). Then, the command reception processing (FIG. 4) for the operation command is finished.

Through such processing of the client device 20 side and the server device 10 side, the video and audio data read from the HDD drive 11 before the operation of the reproduction stop button and buffered by the processing of each of the bit rate conversion circuit 12, the radio transmission/reception processing units 14 and 22, and the MPEG decoder 25 are discarded by operating the reproduction stop button. Subsequently, the video and audio data of the initial screen read from the HDD drive 11 are processed by each of the bit rate conversion circuit 12, the radio transmission/reception processing units 14 and 22, and the MPEG decoder 25 to be sent to the television receiver 40.

In this case, when the video and audio data of the initial screen are sent through the processing of each circuit, the buffer memory area of each circuit is in a free state. Accordingly, the data can be transferred at a higher rate by executing processing faster than normal. By such fast processing and data transfer, the video and the audio of the initial screen are output to the television receiver 40 within a very short time after the operation of the reproduction stop button.

For the other operation commands having data discard commands added thereto, including a reproduction command, a skip reproduction command such as chapter skipping or title skipping, and a fast forward command, similarly to the case of the above, the buffered data of the video and audio data are discarded to quickly respond to the operation.

As described above, the AV transmission system of the embodiment is advantageous in that because the video and audio data are discarded from the buffer memory area of the server device 10 or the client device 20 to quickly execute the process of video and audio data, which reflects the operation during user's operation such as reproduction stop or skip reproduction, a time lag of the operation response can be reduced to provide a good operation feeling to the user.

When it is better to maintain video continuity such as slow reproduction or reverse reproduction, it is possible to maintain continuity of videos without discarding the buffered data of the video and audio data by identifying the operation command to switch processing contents.

Furthermore, regarding user's favorite operation for selecting one operation in which operation response is fasten, such as a fast forward operation, or an operation in which the continuity of video is prioritized, the user can selectively customize which takes priority from the outside by using the remote controller or the like.

The present invention is not limited to the embodiment. Various changes can be made. For example, according to the embodiment, all the buffered data of the video and audio data are discarded when the operation response is made faster. However, even when only main buffered data are discarded, for example, only the buffered data of the bit rate conversion circuit 12 or the MPEG decoder 25 are discarded, it is advantageous for making the operation response faster.

In the embodiment, the system is constructed so that the information regarding the presence of the data discard command is added for each operation command, and execution/nonexecution of the buffered data discarding is switched. However, without providing such addition information, the execution/nonexecution of the buffered data discarding may be switched in accordance with processing contents corresponding to the operation command in the execution process of the operation command. For example, a configuration may be employed where each buffered data is discarded by judging the nonnecessity of maintaining video continuity in the case of an operation command for an operation stop of the MPEG decoder 25, and video continuity is prioritized to inhibit discarding of the buffered data in the case of an operation command which does not stop the MPEG decoder 25.

Furthermore, the types and the number of data processing circuits disposed in the server device or the client device can be changed as occasion demands. A recorder recording the video and audio data does not need to be disposed in the server device. As long as the video and audio data can be read at a high data transfer rate, a configuration may be employed where the server device reads the video and audio data from the external device.

The entire disclosure of Japanese Patent Application No. 2005-087801 filed on Mar. 25, 2005 is incorporated herein by reference in its entirety.

What is claimed is:

1. An AV transmission system comprising:
a server device comprising a bit rate conversion circuit for converting a bit rate of video data and audio data which are continuously sent, a buffer memory for temporarily holding the video data and the audio data to convert the bit rate, a transmission/reception section for transmitting the video and audio data and receiving a command, and a server control unit for executing overall control of the device; and
a client device comprising a transmission/reception section for receiving the video data and the audio data transmitted from the server device and for transmitting the command to the server device, a decoder circuit for decoding a video data and an audio data which are continuously sent and compressed, a buffer memory for temporarily storing the video data and the audio data for the decoding, an operation input unit for inputting an operation command from an outside, and a client control unit for executing overall control of the device, and the client device demodulating the video data and the audio data to a video signal and an audio signal to output the signals, wherein:
the client control unit is configured to discard the data held in the buffer memory of the client device side when the operation input unit inputs a reproduction stop operation command of stopping reproduction of a video and an audio to output another screen, or a reproduction skip operation command of skipping a reproduction position of the video and the audio for a limited time to continue reproduction, and to inhibit discarding of the data held in the buffer memory of the client device side when the operation input unit inputs a speed change operation command of changing a reproduction speed, and
the server control unit is configured to discard the data held in the buffer memory of the server device side when the transmission/reception section receives a command indicating the reproduction stop operation command or the reproduction skip operation command, and to inhibit discarding of the data held in the buffer memory of the server device side when the transmission/reception section receives a command indicating the speed change operation command.

2. An AV transmission system comprising:
a server device comprising a data processing circuit for processing video data and audio data which are continuously sent, a buffer memory for temporarily holding the video data and the audio data to process the data, a transmission/reception section for transmitting the video data and the audio data and receiving a command, and a server control unit for executing overall control of the device; and
a client device comprising a transmission/reception section for receiving the video data and the audio data transmitted from the server device and for transmitting the command to the server device, a data processing circuit for processing the video data and the audio data which are continuously sent, a buffer memory for temporarily storing the video data and the audio data to process the data, an operation input unit for inputting an operation command from an outside, and a client control unit for executing overall control of the device, and the client device demodulating the video data and the audio data to a video signal and an audio signal to output the signals, wherein:
the client control unit is configured to discard the data held in the buffer memory of the client device side and to transmit a command indicating a first operation command to the server device by the transmission/reception section when the operation input unit inputs the first operation command, and
the server control unit is configured to discard the data held in the buffer memory of the server device side when the transmission/reception section receives a command indicating the first operation command.

3. The AV transmission system as claimed in claim 2, wherein:
the client control unit is configured not to discard the data held in the buffer memory of the client device side when the operation input unit inputs a second operation command, and
the server control unit is configured not to discard the data held in the buffer memory of the serer device side when a command indicating the second operation command is received.

4. The AV transmission system as claimed in claim 2, further comprising a setting section for setting whether an operation command input from the outside causes the data of the buffer memory to be discarded or not by an operation from the outside.

5. The AV transmission system as claimed in claim 2, wherein the first operation command contains a reproduction stop operation command of stopping reproduction of a video and an audio to output another screen, or a reproduction skip operation command of skipping a reproduction position of the video and the audio for a limited time to continue reproduction.

6. The AV transmission system as claimed in claim 3, wherein the second operation command contains a speed change operation command of changing a reproduction speed.

7. The AV transmission system as claimed in claim 2, wherein the data processing circuit of the server device comprises a bit rate conversion circuit for converting a bit rate of the video data and the audio data, or a transmission processing circuit for converting the video data and the audio data into a data form which is transmittable by the transmission/reception section.

8. The AV transmission system as claimed in claim 2, wherein the data processing circuit of the client device comprises a decoder circuit for decoding a video data and an audio data which are compressed.
